(19) United States
(12) Patent Application Publication
(10) Pub. No.: US 2018/0040087 A1
(43) Pub. Date: Feb. 8, 2018

(54) Automated Billing Code Generation

(71) Applicant: MModal IP LLC, Franklin, TN (US)

(72) Inventors: Detlef Koll, Pittsburgh, PA (US); Thomas Polzin, Pittsburgh, PA (US); Michael Finke, Pittsburgh, PA (US)

(21) Appl. No.: 15/788,522

(22) Filed: Oct. 19, 2017

Related U.S. Application Data
(63) Continuation of application No. 13/526,684, filed on Jun. 19, 2012.
(60) Provisional application No. 61/498,589, filed on Jun. 19, 2011.

(51) Int. Cl. G06Q 50/22; G06Q 30/04

(52) U.S. Cl. CPC G06Q 50/22; G06Q 30/04

(57) ABSTRACT

A computerized billing code generator reviews billing source data containing both admissible data (such as physician's notes) and inadmissible data (such as nurse's notes). The billing code generator determines whether to generate a request to review the first data based on both the first data and the second data. For example, the billing code generator may generate the request in response to determining that the second data contains information that is inconsistent with information contained in the first data. As another example, the billing code generator may generate the request in response to determining that the second data contains information that is not contained within the first data.

### CROSS-REFERENCE TO RELATED APPLICATIONS

This application is a continuation of U.S. patent application Ser. No. 13/526,684, filed on Jun. 19, 2012, entitled, “Using Alternative Sources of Evidence in Computer-Assisted Billing Coding,” which claims priority from U.S. Provisional Patent Application Ser. No. 61/498,589, filed on Jun. 19, 2011, entitled, “Using Alternative Sources of Evidence in Computer-Assisted Billing Coding,” Attorney Docket Number M0002-1038L; both of which are hereby incorporated by reference.

This application is related to U.S. patent application Ser. No. 13/025,051, filed on Feb. 10, 2011, entitled, “Providing Computable Guidance to Relevant Evidence in Question-Answering Systems,” Attorney Docket Number M0002-1028; U.S. patent application Ser. No. 13/242,532, filed on Sep. 23, 2011, entitled, “User Feedback in Semi-Automatic Question Answering Systems,” Attorney Docket Number M0002-1032; all of which are hereby incorporated by reference.

### BACKGROUND

Physicians and other healthcare professionals (referred to herein generally as “healthcare providers”) must document their encounters with patients so that the resulting documentation can be submitted to the appropriate payer, such as an insurance company or the Centers for Medicare and Medicaid Services (CMS). Failure to create such documentation and to include the required information in the required format can result in refusal by the payer to reimburse the healthcare providers for the medical services they have provided and the costs they have incurred.

Each payer has its own requirements for the content and format of the documentation that must be submitted to obtain payment. For example, to obtain reimbursement for a medical procedure, the corresponding documentation must typically describe both the procedure that was performed and the medical justification for that procedure. Furthermore, payers typically will only provide reimbursement for a medical procedure if the documentation of that procedure was written and/or approved by a physician. Documentation from other sources, such as electronic medical records (EMRs) and notes written by nurses, is not considered admissible for purposes of reimbursement. Therefore, if a particular procedure is documented, for example, in a nurse's notes but not in any physician's notes, then the payer typically will not provide reimbursement for the procedure because no admissible source of evidence has been provided.

Such a system both places a significant burden on physicians to take responsibility for creating records that are admissible as evidence for billing purposes, and excludes a significant amount of documentation for use in justifying and generating bills. What is needed, therefore, are improved techniques for generating bills based on available documentation.

### SUMMARY

A computerized billing code generator reviews billing source data containing both admissible data (such as physician's notes) and inadmissible data (such as nurse's notes). The billing code generator determines whether to generate a request to review the first data based on both the first data and the second data. For example, the billing code generator may generate the request in response to determining that the second data contains information that is inconsistent with information contained in the first data. As another example, the billing code generator may generate the request in response to determining that the second data contains information that is not contained within the first data.

In one aspect, a method includes identifying first data relating to a fact, wherein the first data is admissible in a billing process. The method includes identifying second data relating to the fact, wherein the second data is not admissible in the billing process. The method includes deciding, based on the first data and the second data, whether to generate a request to review the first data.

In another aspect, a system includes a billing code generator executing on a computing device. The system includes a data identification component executed by the billing code generator, identifying first data relating to a fact, wherein the first data is admissible in a billing process and identifying second data relating to the fact, wherein the second data is not admissible in the billing process. The system includes a data analysis component executed by the billing code generator and deciding, based on the first data and the second data, whether to generate a request to review the first data.

In still another aspect, a method includes determining to generate a request to review first data relating to a fact, based on an analysis of the first data and second data relating to the fact, wherein the first data is admissible in a billing process and the second data is not admissible in the billing process. The method includes generating a proposed request to review the first data. The method includes requesting, from a user, review of the proposed request. The method includes determining that the user accepted the proposed request. The method includes generating a final request based on determining that the user accepted the proposed request

Other features and advantages of various aspects and embodiments of the present invention will become apparent from the following description and from the claims.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting one embodiment of a system for using alternative sources of evidence in computer-assisted billing coding;

FIG. 1B is a block diagram depicting one embodiment of a system in which a billing code generator associates a data source with a unit of billing source data;

FIG. 1C is a block diagram depicting one embodiment of a system in which a billing code generator associates an admissibility value with a unit of billing source data;

FIG. 1D is a block diagram depicting one embodiment of a system in which a billing code generator associates a weight with a unit of billing source data;

FIG. 1E is a block diagram depicting one embodiment of a system in which a billing code generator associates a data source, an admissibility value, and a weight with a unit of billing source data;

FIG. 2A is a flow diagram depicting one embodiment of a method for using alternative sources of evidence in computer-assisted billing coding;

FIG. 2B is a flow diagram depicting one embodiment of a method for identifying units of billing source data and associating a data source, an admissibility value, and a weight with each unit of billing source data;

FIG. 2C is a flow diagram depicting one embodiment of a method for determining whether to request review of first data, based on a determination that the first data and second data are inconsistent;

FIG. 2D is a flow diagram depicting one embodiment of a method for determining whether to request review of first data, based on an analysis of a weight assigned to second data;

FIG. 2E is a flow diagram depicting one embodiment of a method for determining whether to request review of first data, based on a determination that the first data is missing information contained in second data;

FIG. 2F is a flow diagram depicting one embodiment of a method for determining whether to request review of first data, based on an analysis of an admissibility value assigned to second data;

FIG. 2G is a flow diagram depicting one embodiment of a method for determining whether to request review of first data, based on an analysis of a weight assigned to second data and of a weight assigned to third data;

FIG. 2H is a flow diagram depicts one embodiment of a method in which the billing code generator decides whether to generate a request to review a billing code;

FIG. 2I is a flow diagram depicting one embodiment of a method in which the billing code generator modifies a level of confidence associated with a generated billing code; and

FIG. 3 is a flow diagram depicting one embodiment of a method for generating a request for review of first data relating to a fact, based on an analysis of the first data and second data relating to the fact.

### DETAILED DESCRIPTION

Despite the increasingly widespread use of electronic medical records (EMRs) and other structured data in the healthcare field, many physicians still create medical reports in the form of freeform narrative notes, which are a kind of unstructured data. Such notes often are stored in conventional word processing documents, such as Microsoft Word documents. For example, after a physician has completed a visit with a patient, the physician may type or dictate a report of the visit into a word processing document. Such a record may include, for example, information such as the date of the visit, the patient's name and other identifying information, the patient's recent medical history, any complaints voiced by the patient, the physician's observations, any diagnoses made by the physician, any medications prescribed by the physician, and any procedures performed by the physician on the patient. Such indications in the record may be referred to as “facts.”

At some time after the visit, a human expert, known as a “billing coder,” reads the physician's report (or possibly the report in addition to other related reports and documents) to derive appropriate billing codes that may be used to generate a bill for the patient's visit. For example, if the billing coder finds that the report indicates that the physician performed a certain procedure on the patient, the billing coder may generate a billing code corresponding to that procedure. Different procedures typically are, but need not be, associated with different billing codes.

Because the physician's report and other documents reviewed by the billing coder may contain freeform narrative text, the billing coder's task typically requires not only the ability to read and understand such text, but also a knowledge of the applicable billing codes and of the rules that permit billing codes to be generated based on available evidence. Such rules include, for example, rules defining the correspondence between medical procedures and billing codes, and rules governing the admissibility of evidence for generating billing codes. For example, such rules may dictate that only information generated or approved by a physician is admissible, and that only such information may therefore be used as the justification for generating billing codes.

The data reviewed by a human billing coder may contain incomplete or inconsistent information (or “facts”), in which case the billing coder may need to contact the physician to ask for additional information or clarification, respectively. Any such information received from the physician is typically provided as an addendum to the originally-provided information. For example, if the physician's notes indicate that the physician administered cortisone to the patient but the notes do not indicate the dosage applied, the billing coder may need to contact the physician to obtain the administered dose and to provide an indication of the administered dose in an addendum.

In the example provided above, the billing coder could determine that required information was missing merely by examining the physician's notes. As mentioned above, the physician's notes are admissible evidence for purposes of bill generation. In other cases, however, the billing coder may determine that information required to generate a bill is missing, or that inconsistent information has been provided, based in whole or in part on inadmissible evidence, such as the contents of electronic medical records and/or nurse's notes. One example of inadmissible data is data in an HR7-CCD (Continuity of Care Document). Certain regulations require EMR systems to provide data in an HR7-CCD record. Yet the information contained in an HR7-CCD record typically is inadmissible as evidence for billing purposes.

If the billing coder discovers that the physician's notes indicate that the physician administered 50 mg of cortisone but the nurse's notes indicate that the dosage was 100 mg, this inconsistency may cause the billing coder to contact the physician for clarification. As another example, if the physician's notes do not indicate that cortisone was administered, but the nurse's notes indicate that 100 mg of cortisone was administered, this inclusion of information in the nurse's notes that is not contained in the physician's notes may cause the billing coder contact the physician to provide the missing information or to confirm that the nurse's notes are incorrect.

Computer-assisted billing coding (CAC) systems apply natural language processing (NLP) technology to improve the productivity and consistency of human billing coders. An example of such a CAC system is described in co-pending and commonly-owned U.S. patent application Ser. No. 13/025,051, filed on Feb. 10, 2011, entitled, “Providing Computable Guidance to Relevant Evidence in Question-Answering Systems,” which is hereby incorporated by reference herein.

Embodiments of the present invention may be used to increase the accuracy and completeness of the billing codes generated by CAC systems by enabling such systems to make use of alternative sources of data (i.e., data sources that are not admissible as evidence for purposes of bill generation) to generate billing codes.

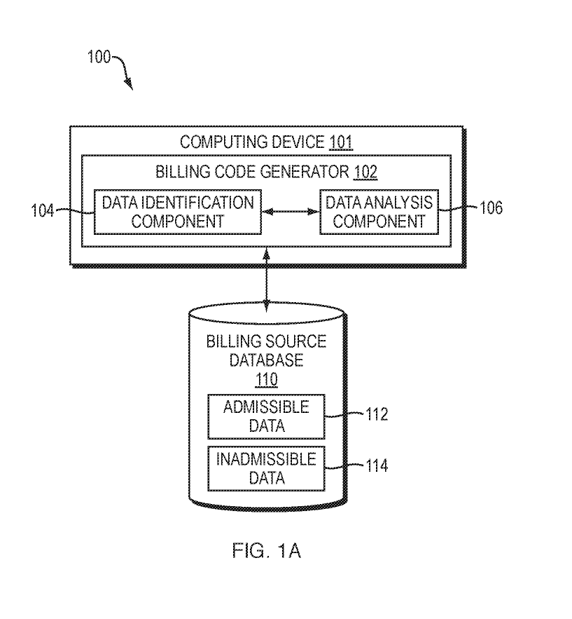

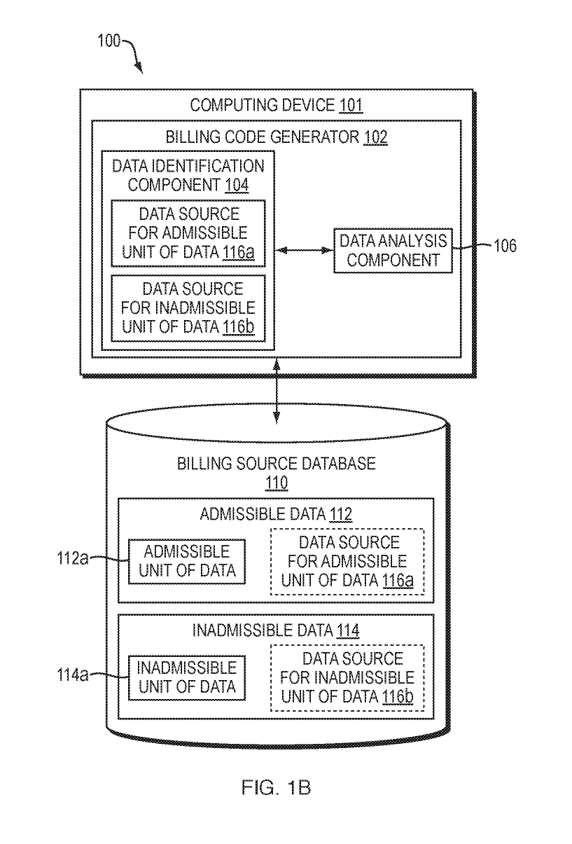

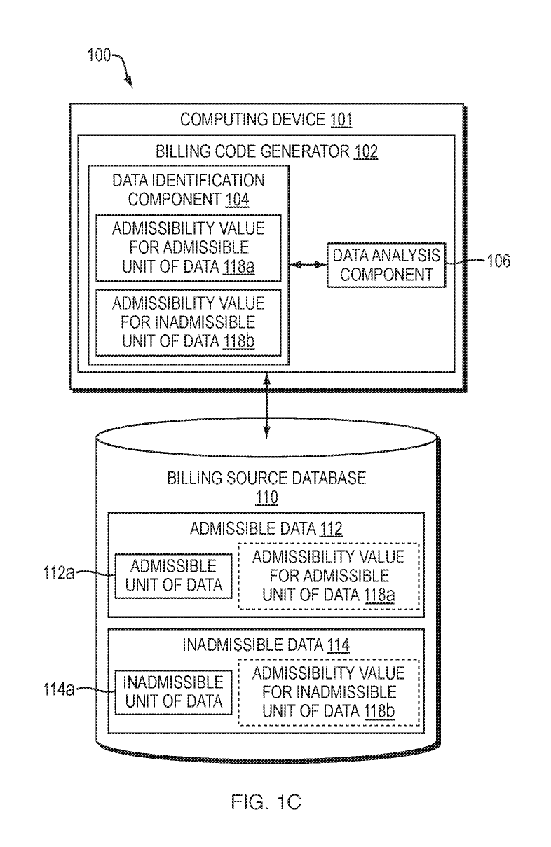

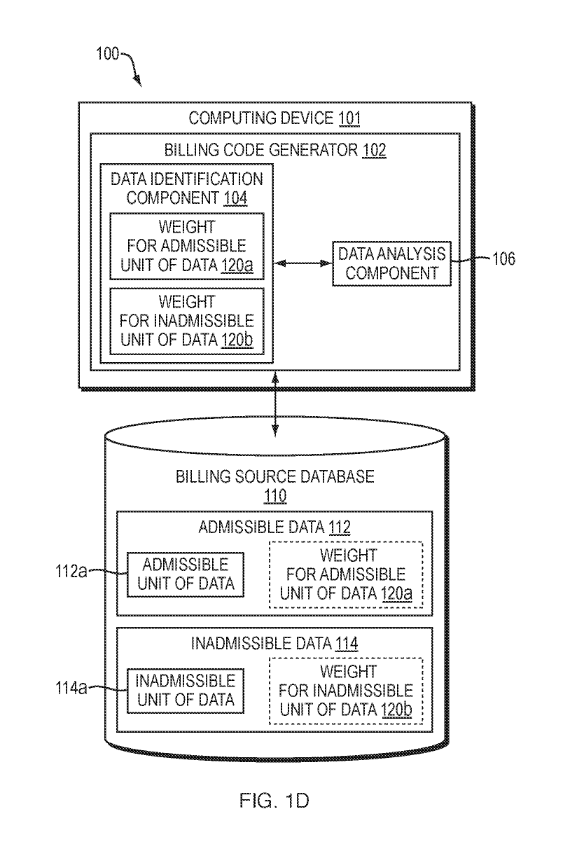

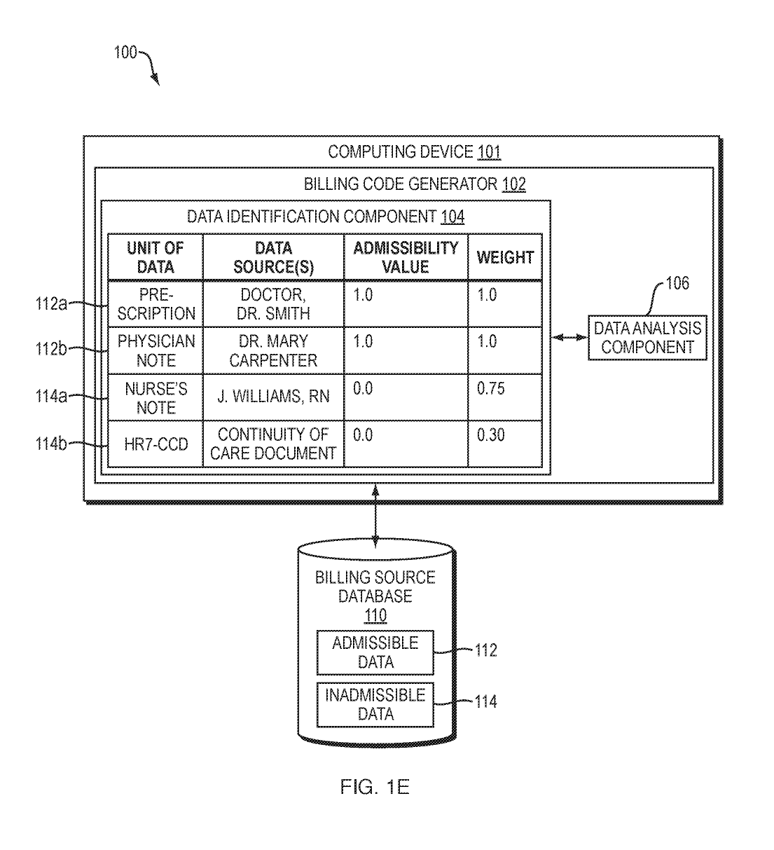

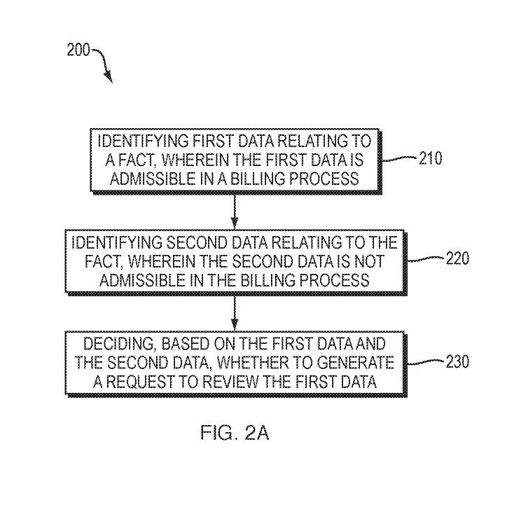

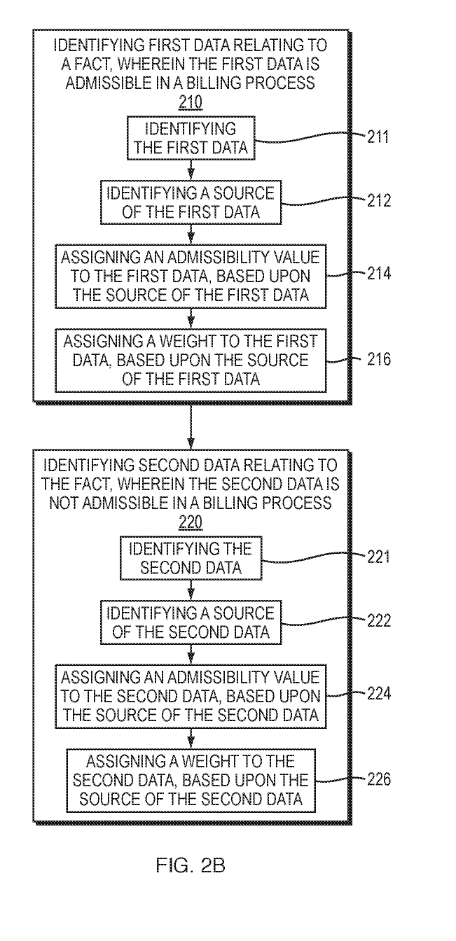

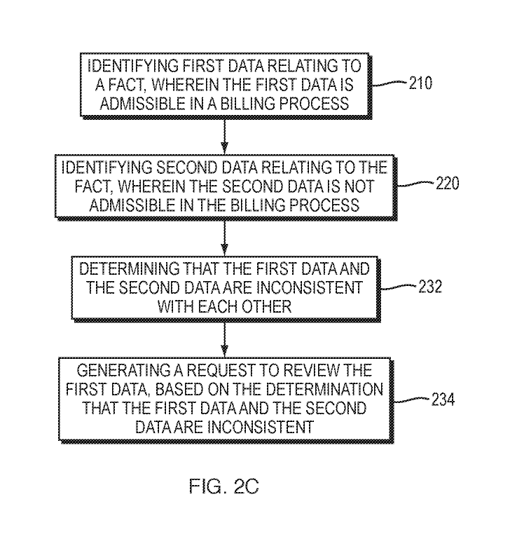

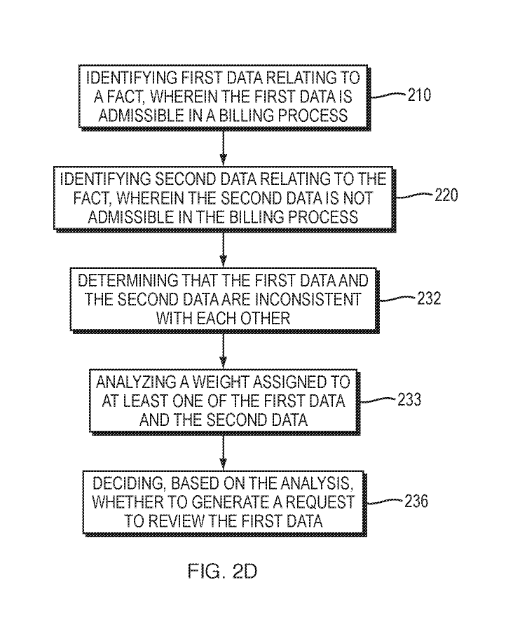

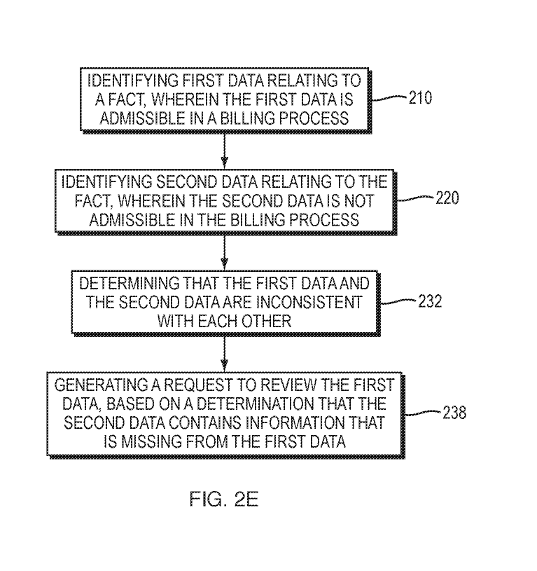

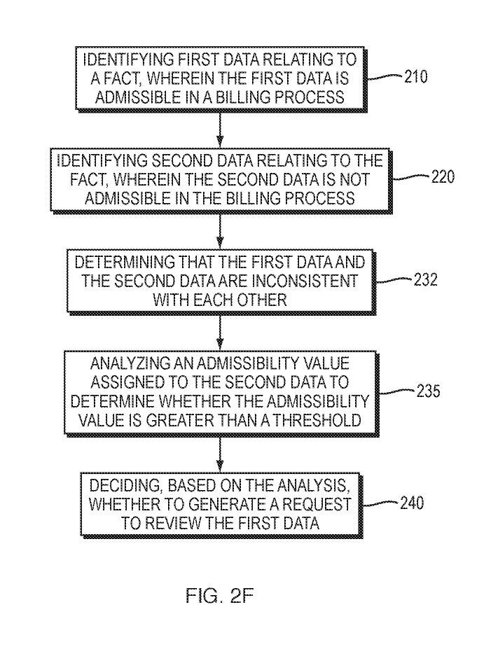

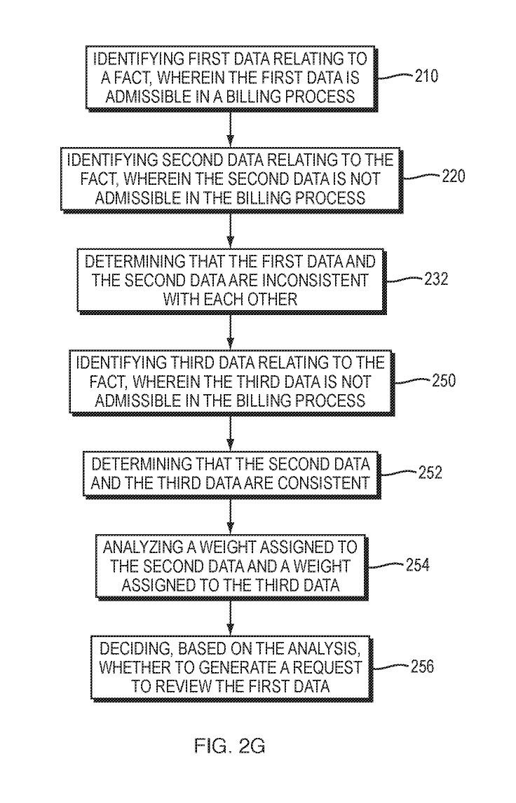

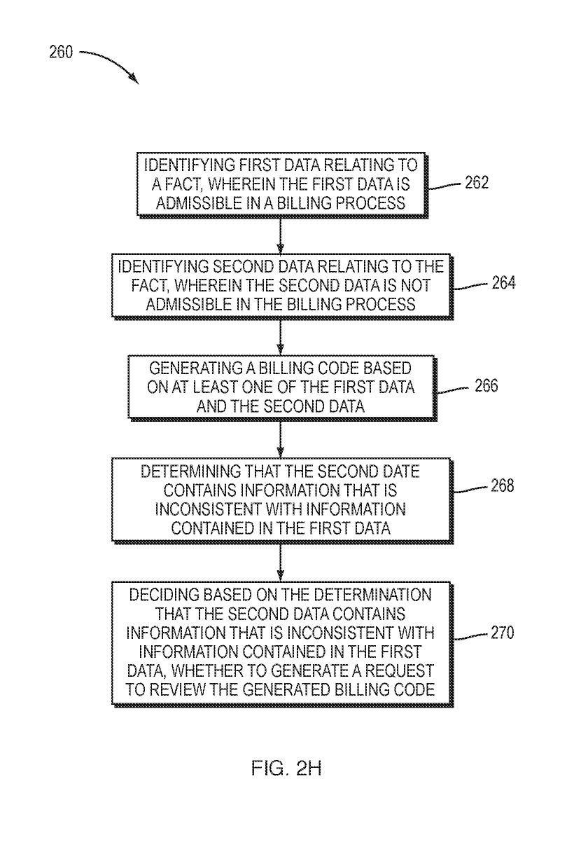

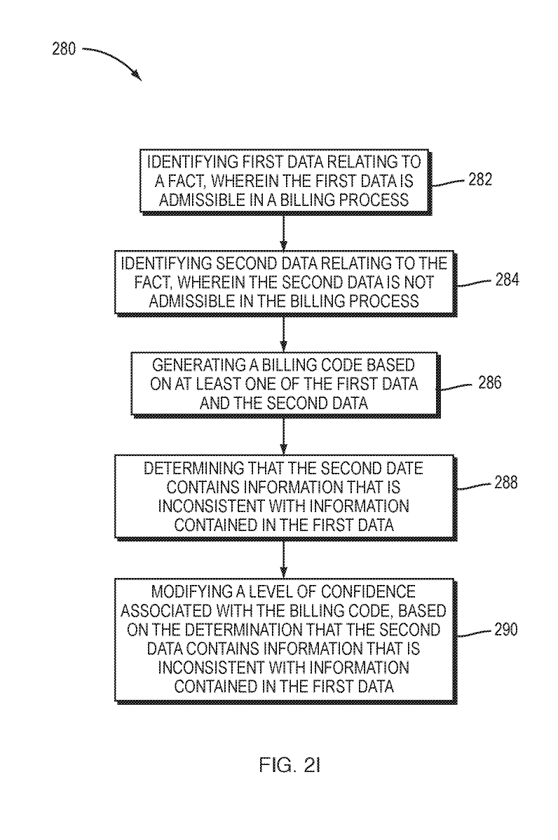

Referring to FIGS. 1A and 2A, a method 200 for using alternative sources of evidence in computer-assisted billing coding includes identifying first data relating to a fact, wherein the first data is admissible in a billing process (210). The method 200 includes identifying second data relating to the fact, wherein the second data is not admissible in the billing process (220). The method 200 includes deciding, based on the first data and the second data, whether to generate a request to review the first data (230). In one embodiment, a billing code generator 102 executing on a computing device 101 identifies the first data relating to the fact. In another embodiment, a data identification component 104 of the billing code generator 102 identifies the first data relating to the fact. In still another embodiment, the billing code generator 102 identifies the second data relating to the fact. In yet another embodiment, the data identification component 104 of the billing code generator 102 identifies the second data relating to the fact. The data identification component 104 may perform fact correlation while the data analysis component 106 may perform analysis of data and determine whether to request additional review of the data.

As discussed above, facts may be information included in a data source admissible in a billing process that the billing code generator 102 reviews and associates with a billing code. Examples include information such as the date of the visit, the patient's name and other identifying information, the patient's recent medical history, any complaints voiced by the patient, the physician's observations, any diagnoses made by the physician, any medications prescribed by the physician, and any procedures performed by the physician on the patient. By way of example, the data identification component 104 may identify a fact (such as an indication that the physician administered medicine to a patient), first data relating to the fact (such as a physician's note indicating that a physician administered a certain dosage of medication for a patient) and second data relating to the fact (such as a nurse's note indicating that the physician administered a different dosage of medication for the patient).

In general, a computerized billing code generator 102 implemented according to embodiments of the methods and systems described herein may have access to a variety of data which may possibly contain information that is relevant to the generation of billing codes for a bill. The set of data accessed by the billing code generator when generating a bill is referred to herein as “billing source data.” Information that is “relevant” to the generation of billing codes may include both admissible and inadmissible information. In one embodiment, and as depicted in FIG. 1A, a billing source database 110 stores the billing source data. In another embodiment, the data identification component 104 queries the billing source database 110 to identify the first data and the second data.

Billing source data may include any of a variety of data, such as freeform text documents, structured documents, electronic medical records, scanned documents (e.g., handwritten progress notes), and other kinds of database records. Such data may have been entered manually or created (manually and/or automatically) based on speech. Structured documents in billing source data may, for example, have been created using techniques disclosed in U.S. Pat. No. 7,584,103 B2, issued on Sep. 1, 2009, entitled, “Automated Extraction of Semantic Content and Generation of a Structured Document from Speech.”

When generating a bill for a particular patient encounter, the billing source data may include only data related to that particular patient encounter, or may include both such data and other data, such as information about other encounters with the same patient or other information about the patient. By way of example, the data identification component 104 may identify data (either admissible data 112 or inadmissible data 114 or both) that relates to a specific patient encounter such as, without limitation, a specific appointment between a healthcare professional and a patient, a specific diagnosis made during the specific appointment, and a specific prescription written for the patient. In one embodiment, the data analysis component 106 determines, based upon second data including data associated with a patient encounter, to generate the request to review the first data. As another example, the data identification component 104 may identify data (either admissible data 112 or inadmissible data 114 or both) that relates to a plurality of patient encounters such as, without limitation, previous diagnoses, previous prescriptions, and previous medical procedures. In another embodiment, the data analysis component 106 determines, based upon second data including data associated with a plurality of patient encounters, to generate the request to review the first data.

Referring ahead to FIG. 2B, and in connection with FIGS. 1A-1E, a flow diagram depicts one embodiment of identifying first and second data, providing additional detail to (210) and (220) from FIG. 2A above. In the embodiment depicted in FIG. 2B, identifying first data relating to a fact (210) includes identifying the first data (211), identifying a source of the first data (212), assigning an admissibility value to the first data, based upon the source of the first data (214), and assigning a weight to the first data, based upon the source of the first data (216). In the embodiment depicted in FIG. 2B, identifying second data relating to the fact (220) includes identifying the second data (221), identifying a source of the second data (222), assigning an admissibility value to the second data, based upon the source of the second data (224), and assigning a weight to the second data, based upon the source of the second data (226).

In some embodiments, the billing code generator 102 receives a plurality of data including the first data and the second data (as well as, in some instances, documentation related to a patient encounter) with a request to generate billing codes. For example, a component such as an electronic master patient index (eMPI) may search the billing source database 110 for data relevant to the request and provide that data to the billing code generator 102. Alternatively, the billing code generator 102 may receive the plurality of data (such as documentation related to a patient encounter) with the request. As another example, the billing code generator 102 may receive a structured data source containing the plurality of data. For example, the data identification component 104 may be a component that accesses structured data sources to identify a plurality of records relevant to a request for generating billing codes. In other embodiments, the billing code generator 102 has access to the billing source database 110 and retrieves the first data and the second data. For example, the billing code generator 102 may search for data in the billing source database 110 having a common identifier (e.g., a common medical record number, patient identifier, or other common identifier). In one example, the billing code generator 102 is in communication with an electronic master patient index (eMPI) and may use the eMPI to identify user identifiers (such as patient or physician identifiers) across clinical systems (e.g., from one or more systems including, without limitation, lab systems, admissions systems, and electronic medical records systems); with that user identifier, the billing code generator 102 can then query clinical systems for data relating to particular facts.

Referring now to FIG. 2B, and in connection with FIG. 1B, the data identification component 104 associates a data source with each of one or more units of data in the billing source data. In one embodiment, the data identification component 104 generates the data source 116a associated with an admissible unit of data 112a. In another embodiment, the data identification component 104 generates the data source 116b for an inadmissible unit of data 114a. In still another embodiment, the data identification component 104 analyzes a unit of data in the billing source database 110 and determines, based on information contained within the data what data source 116 to associate with the unit of data. By way of example, information in the unit of data may identify a type of data (e.g., by including as part of the unit of data or as part of metadata associated with the unit of data, the type of data, such as “nurse's note”), from which the data identification component 104 can infer the data source (e.g., a nurse).

In one embodiment, the data identification component 104 stores the generated data source 116 (e.g., on the computing device 101). In such an embodiment, the data identification component 104 may include a link to or identifier of the unit of data associated with the data source 116. In yet another embodiment, and as depicted in shadow in FIG. 1B, the data identification component 104 stores the data source 116 in the billing source database 110.

In some embodiments, rather than generate new data sources, the data identification component 104 identifies a data source within an admissible unit of data 112 or an inadmissible unit of data 114. In one of these embodiments, the unit of data explicitly identifies the data source. As one example, information in the unit of data may identify a name or title of a person or system generating the unit of data (e.g., Dr. Smith or an identification of an Electronic Medical Records System). Examples of data sources include categories (such as “physician,” “nurse,” and “automatically generated”) and identifiers of individual sources (such as “Dr. Mary Carpenter” and “Nurse Jane Williams”). A unit of data may be associated with multiple data sources 116 (e.g., both “physician” and “Dr. Mary Carpenter”).

Referring now to FIG. 2B, and in connection with FIGS. 1B and 1C, in one embodiment, the data identification component 104 assigns an admissibility value 118 to each of one or more units of data in the billing source data. In one embodiment, the data identification component 104 assigns a binary admissibility value 118 (e.g., a value of zero indicating that the data is not admissible or a value of one indicating that the data is admissible). In another embodiment, the data identification component 104 assigns an admissibility value selected from a range of non-binary values (e.g., continuous values between a range such as, without limitation, 0-1 or 0-100). As shown in FIG. 1C, the data identification component 104 assigns an admissibility value 118a for an admissible unit of data 112a and assigns an admissibility value 118b for an inadmissible unit of data 114a. In one embodiment, the data identification component 104 assigns an admissibility value 118 to a particular unit of data based on the data source(s) 116 associated with the unit of data. For example, an admissibility value of 1.0 (or “admissible”) may be assigned to data generated and/or approved by a physician, and an admissibility value of 0.0 (or “inadmissible”) may be assigned to data generated and/or approved by a nurse. These particular values are merely examples and do not constitute limitations of the present invention. As an alternative example, the data identification component 104 accesses a rules engine to determine whether data is admissible. For instance, the data identification component 104 may evaluate a rule indicating that if a doctor's note specifies one drug was prescribed and a nurse's note specifies a different drug, that is a conflict and the system should generate a request to review the doctor's note; the data identification component 104 may draw the conclusion that such a rule has an implicit indication that the nurse's note is inadmissible, even if no admissibility value is associated with the nurse's note explicitly.

In one embodiment, the data identification component 104 stores the generated admissibility value 118 (e.g., on the computing device 101). In such an embodiment, the data identification component 104 may include a link to or identifier of the unit of data associated with the admissibility value 118. In yet another embodiment, and as depicted in shadow in FIG. 1C, the data identification component 104 stores the admissibility value 118 in the billing source database 110.

Referring now to FIG. 2B, and in connection with FIGS. 1B and 1D, in one embodiment, the data identification component 104 assigns a weight 120 to each of one or more units of data in the billing source data. In one embodiment, the data identification component 104 assigns the weight 120 to a particular unit of data based on the data source(s) 116 associated with the unit of data. For example, a weight of 1.0 may be assigned to data generated and/or approved by a physician, and an admissibility value of 0.0 may be assigned to data generated and/or approved by a nurse. These particular values are merely examples and do not constitute limitations of the present invention.

Referring now to FIG. 1E, a block diagram depicts one embodiment of units of data associated with a data source, an admissibility value, and a weight. FIG. 1E depicts an example, without limitation, of different types of data units and provides example values for each. As shown in FIG. 1E, admissible data unit 112a is a prescription associated with two data sources 116 (“doctor” and “Dr. Smith” and associated with an admissibility value of 1.0 and a weight of 1.0, where as inadmissible data unit 114a is a nurse's note associated with one data source (“L. Nguyen, RN”), an admissibility value of 0.0, and a weight of 0.75.

Referring back to FIG. 2A, the method 200 includes deciding, based on the first data and the second data, whether to generate a request to review the first data (230). In one embodiment, the billing code generator 102 determines to generate a request to clarify the first data. In another embodiment, the billing code generator 102 determines to generate a request to add, remove, or otherwise modify information the first data. In still another embodiment, the billing code generator 102 determines to generate a request to review the first data based upon the second data.

In one embodiment, the billing code generator 102 generates a request to review a billing code generated based upon at least one of the first data and the second data, which may provide a user of the system with an opportunity to confirm that the billing code generator 102 generated an appropriate billing code. As another example, requesting review of data may provide a user with an opportunity to clarify inconsistencies between data or otherwise lessen a level of impact that omitted or inaccurate data may have on the user, on the accuracy of billing data, and/or on a level of care provided. Billing code generators implemented according to embodiments of the methods and systems described herein may process billing source data to determine whether to generate a request to obtain missing information and/or to clarify inconsistent information for the purpose of generating billing codes. The decision to generate such a request may be based in whole or in part on inadmissible evidence.

Referring now to FIG. 2C, and in connection with FIGS. 1A-1E, a flow diagram depicts an embodiment in which the billing code generator 102 decides whether to generate the request to review the first data based upon a determination that the first data and the second data are inconsistent with each other (232). The data analysis component 106 may determine that the first data and the second data are inconsistent with each other. The billing code generator 102 generates a request to review the first data, based on the determination that the first data and the second data are inconsistent (234). For example, the data analysis component 106 may determine that a unit of admissible data 112 (e.g., a physician's note) specifies one dosage of medicine administered (e.g., indicates that the physician administered 50 mg of cortisone) and also determines that a unit of inadmissible data 114 (e.g., a nurse's note) specifies a different dosage of medicine administered (e.g., indicates that the dosage was 100 mg); this may cause the billing code generator 102 to generate a request to contact the physician for clarification. This is an example in which a request is generated based on a determination that two units of data in the billing source data are inconsistent with each other. The billing code generator 102 may be configured to generate a request if an inconsistency is found in any one or more of the following three cases: (1) an inconsistency between two units of admissible data; (2) an inconsistency between a unit of admissible data and a unit of inadmissible data; and (3) an inconsistency between two units of inadmissible data.

As another example, the billing code generator 102 may identify inconsistencies other than inconsistencies between the first data and the second data, such as, without limitation, omissions of data. For example, a coder may omit a billing code that would be supported by inadmissible evidence (e.g., a physician omitted a billing code while a nurse's note provided inadmissible evidence that would have supported the inclusion of the billing code by the doctor). The billing code generator 102 may also identify an inconsistency when the billing code generator 102 does not have access to a unit of data. For example, if there is admissible information in a patient's chart, such as a scanned note included in the data provided to the billing code generator 102, but the billing code generator 102 does not have the functionality to analyze the format or type of information, the billing code generator 102 may rely on inadmissible data to support a billing code, while determining to generate a request to review the billing code.

Alternatively, the billing code generator 102 may determine to generate the request if there are no inconsistencies. For example, the billing code generator 102 may analyze data related to a fact, determine that the data are consistent, and generate a suggested billing code; however, in some instances, the billing code generator 102 may determine that a level of confidence in generating the suggested billing code is below a predetermined threshold. In such an example, the billing code generator 102 may increase a level of confidence associated with a generated billing code based on analysis of second data, which may be inadmissible data but which provides sufficient support to increase the level of confidence. In this example, the billing code generator 102 may avoid having to request review of the billing code if, for example, the increased level of confidence exceeds the predetermined threshold for triggering required review.

Referring now to FIG. 2D, and in connection with FIGS. 1A-1E, a flow diagram depicts an embodiment in which the billing code generator 102 determines whether to generate the request to review the first data based upon an analysis of a weight assigned to at least one of the first data and the second data. As in FIG. 2C, the data analysis component 106 determines that the first data and the second data are inconsistent (232). The data analysis component 106 analyzes a weight assigned to at least one of the first data and the second data (233). The billing code generator 102 determines, based on the analysis, whether to generate a request to review the first data (236). As shown in FIG. 2D, in some embodiments, the weight assigned to evidence is taken into account when determining whether to generate a request to contact the physician for clarification. For example, any particular unit of data may be ignored if its weight falls below a predetermined threshold, such that an inconsistency between that unit of data and another unit of data will not trigger the generation of a request to contact the physician for clarification. More generally, any criteria or procedure may be applied to the weight of a particular unit of data to determine the influence of that unit of data on the decision whether to generate a request to contact the physician for clarification.

Referring now to FIG. 2E, and in connection with FIGS. 1A-1E, a flow diagram depicts an embodiment in which the billing code generator 102 determines whether to generate the request to review the first data based upon a determination that the second data contains information that is not contained within the first data. As in FIG. 2C, the data analysis component 106 determines that the first data and the second data are inconsistent (232). The billing code generator 102 generates a request to review the first data, based on a determination that the second data contains information that is missing from the first data (238). As an example, if the physician's notes (e.g., admissible first data) do not indicate that cortisone was administered, but the nurse's notes (e.g., inadmissible second data) indicate that 100 mg of cortisone was administered, this may cause the billing code generator 102 to contact the physician to provide the missing information or to confirm that the nurse's notes are incorrect. This is an example in which a request is generated based on a determination that required information is missing from an admissible source of data, based the presence of such information in an inadmissible source of data. The billing code generator 102 may be configured to generate a request if information is determined to be missing in any one or more of the following four cases: (1) information that is present in inadmissible data but missing in admissible data; (2) information that is present in admissible data but missing in inadmissible data; (3) information that is present in one source of admissible data but missing from another source of admissible data; and (4) information that is present in one source of inadmissible data but missing from another source of inadmissible data.

As shown in FIG. 2F, in some embodiments, the admissibility value 118 assigned to evidence is taken into account when determining whether to generate a request to contact the physician to provide missing information or to clarify inconsistent data. The data analysis component 106 determines that the first data and the second data are inconsistent (232). The data analysis component 106 analyzes an admissibility value 118 assigned to the second data 114 to determine whether the admissibility value is greater than a threshold (235). The data analysis component 106 decides whether to generate the request to review the first data, based upon the analysis of the admissibility value 118 (240). For example, any particular unit of data may be ignored if its admissibility value falls below a predetermined threshold, such that information that is present in or missing from that unit of data will not trigger the generation of a request to contact the physician for missing information. Such a threshold may, for example, vary depending on whether the physician or other user is currently inputting the information or whether the prompt is being generated after the prompt-triggering information has been entered (e.g., after the user has dictated the entire report and the report has been recorded and transmitted to a remote location for processing). More generally, any criteria or procedure may be applied to the admissibility value of a particular unit of data to determine the influence of that unit of data on the decision whether to generate a request to contact the physician for missing information.

In some embodiments, the data analysis component 106 takes multiple factors into account when determining whether to generate a request for review of data. In one of these embodiments, an analysis, for example, of just the weight value or of just the admissibility value might indicate that no request should be made. For example, referring to FIG. 1E, an analysis of just the admissibility value of Nurse's Note 114a (which, in FIG. 1E, is 0.0) might indicate that the doctor should not be interrupted with a request for clarification or additional information. However, if the data analysis component 106 considers both the weight for Nurse's Note 114a (e.g., 0.75) and the admissibility value (e.g., 0.0), the data analysis component 106 may determine instead to generate a request for clarification or additional information. In another of these embodiments, therefore, the data analysis component 106 determines to generate the request to review the first data, based upon an analysis of an admissibility value 118 assigned to the second data and an analysis of a weight 120 assigned to the second data. In still another of these embodiments, the data analysis component 106 compares the values to pre-determined thresholds; if the first data contains information that is inconsistent with the second data and if a weight value of the second data is higher than a weight threshold, even if an admissibility value for the second data is lower than an admissibility threshold, the data analysis component 106 may determine to generate the request for review of the first data. As one particular example, data that has a relatively high weight but a relatively low admissibility value may be used as the basis for generating a request to a physician if, for example, the data contains information that is missing from or inconsistent with data having a relatively high admissibility value. By way of example, a weight that exceeds a particular weight threshold may be considered relatively high, while an admissibility value that falls below an admissibility threshold may be considered relatively low. As another example, the weight may be relatively high (or low) as compared to other weights; as shown in the example depicted in FIG. 1E, inadmissible data 114a has a weight of 0.75, which may be considered relatively high when compared to the weight of 1.0 assigned to admissible data 112; alternatively, the weight of 0.75 may be considered relatively high compared to a threshold (not shown) of 0.5. The threshold for admissibility value and the threshold for weight may be the same as or different from each other.

Referring now to FIG. 2G, and in connection with FIGS. 1A-1E, the weights of multiple units of data relating to the same fact may be combined together by addition or any other function to produce a combined weight. In one embodiment, the data identification component 104 identifies third data relating to the fact, wherein the third data is not admissible in the billing process; the data analysis component 106 determines to generate the request to review the first data, based upon an analysis of a weight assigned to the second data and an analysis of a weight assigned to the third data. Referring back to FIG. 1E, by way of example, an analysis of just the HR7-CCD 114b data might indicate that with a weight of 0.30, the system should not request additional or clarifying information. However, and continuing with the example depicted in FIG. 1E, should the data analysis component 106 analyze both the weight of data 114b and of data 114a (Nurse's Note 114a), the combined weights (in an embodiment in which the weights are simply added, for example) would equal 1.05 and might indicate to the data analysis component 106 that the billing code generator 102 should request additional or clarifying information. As another example, consider notes from multiple nurses about a particular procedure performed on a patient during a particular visit. Assume that the physician writes a report of the patient visit that does not mention the particular procedure, but that all three nurses write reports mentioning that the procedure was performed. Assume further that the weight assigned to each nurse's report is 0.25. The billing code generator 102 may recognize that all three nurse's reports mention the same fact, and combine the weights associated with the three reports, such as by summing them, to provide a combined weight of 0.75. The billing code generator 102 may also recognize that the physician report relating to the same patient visit does not mention the same fact. The billing code generator 102 may then determine that the nurses' reports should be used as the basis to generate a request to the physician to provide the missing information because, for example, the combined weight of 0.75 exceeds some predetermined threshold (e.g., 0.5) or otherwise satisfies some predetermined criteria. Note that such a request may be generated even if the nurse's reports have low admissibility values, even admissibility values as low as zero.

Referring now to FIG. 2H, a flow diagram depicts one embodiment of a method 260 in which the billing code generator 102 decides whether to generate a request to review a billing code. Although described in the examples above in the context of generating a request to review data, the systems and methods described herein may also be used to determine whether to generate a request to review a billing code. The method 260 includes identifying first data relating to a fact, wherein the first data is admissible in a billing process (262). The method 260 includes identifying second data relating to the fact, wherein the second data is not admissible in the billing process (264). The identification of first data and of second data may occur as described above in connection with FIGS. 2A-2G. The method 260 includes generating a billing code based on at least one of the first data and the second data (266). As indicated above, the billing code generator 102 may include functionality for generating a billing code associated with a fact based upon an analysis of data relating to the fact. The method 260 includes determining that the second data contains information that is inconsistent with information contained in the first data (268). The determination that the second data and the first data contain inconsistent information may occur as described above in connection with FIGS. 2A-2G. The method 260 includes deciding, based on the determination that the second data contains information that is inconsistent with information contained in the first data, whether to generate a request to review the generated billing code (270). The billing code generator 102 may make the determination to generate the request to review the generated billing code in a substantially similar manner as the billing code generator 102 determines whether to generate requests to review the first data. In some embodiments, the billing code generator 102 may determine to generate both a request to review the billing code and a request to review the first data.

Referring now to FIG. 2I, a flow diagram depicts one embodiment of a method 260 in which the billing code generator 102 modifies a level of confidence associated with a generated billing code. Although described in the examples above in the context of generating a request to review data, the systems and methods described herein may also be used to determine whether to modify levels of confidence associated with billing codes, based on analyses of underlying data supporting the billing codes. The method 280 includes identifying first data relating to a fact, wherein the first data is admissible in a billing process (282). The method 280 includes identifying second data relating to the fact, wherein the second data is not admissible in the billing process (284). The identification of first data and of second data may occur as described above in connection with FIGS. 2A-2G. The method 280 includes generating a billing code based on at least one of the first data and the second data (286). As indicated above, the billing code generator 102 may include functionality for generating a billing code associated with a fact based upon an analysis of data relating to the fact. The method 280 includes determining that the second data contains information that is inconsistent with information contained in the first data (288). The determination that the second data and the first data contain inconsistent information may occur as described above in connection with FIGS. 2A-2G. The method 280 includes modifying a level of confidence associated with the billing code, based on the determination that the second data contains information that is inconsistent with information contained in the first data (290). As indicated above in connection with FIG. 2C, the billing code generator 102 may associate a level of confidence with a generated billing code—for example, if the billing code generator 102 determines that all the data related to a fact for which a billing code is generated is consistent and support the billing code, the billing code generator 102 may assign a high level of confidence to the billing code. In other instances, however, such as where there is inconsistent data, the billing code generator 102 may assign a lower level of confidence. In one embodiment, the billing code generator 102 increases the level of confidence associated with a billing code, based on the determination that the second data contains information that is inconsistent with information contained in the first data. As an example, the billing code generator 102 may analyze inadmissible data that supports assigning a particular billing code to a fact and may also analyze admissible data that includes data supportive of assigning a particular billing code but is missing information needed to assign a high level of confidence in the assignation of the billing code to the fact; in such an example, the billing code generator 102 may have generated a billing code with a low level of confidence and then increased the level of confidence upon analyzing the inadmissible data. In another embodiment, the billing code generator 102 decreases the level of confidences associated with a billing code, based on the determination that the second data contains information that is inconsistent with information contained in the first data.

In some embodiments, the billing code generator 102 may analyze a cost of generating the request to determine whether to generate the request. For example, the billing code generator 102 may analyze how expensive a request is in terms of physician disruption. In such an embodiment, the cost might vary depending on what user, or type of user, receives the request—a doctor's time in reviewing and responding to a request may be more expensive than a nurse's time and the nurse's time may be more expensive than that of a computerized system, such as an electronic medical records system. Additionally, the cost might vary depending on when the request is generated. For example, a real time interruption of a physician may be more costly than generating the request but storing it for review by the physician at a convenient time.

In other embodiments, the billing code generator 102 may analyze a value of generating the request to determine whether to generate the request. For example, if generating the request and receiving confirmation or modification of the first data would have a substantially material impact on the generated billing codes or a level of care, the billing code generator 102 may determine to generate the request. As another example, the billing code generator 102 may determine that an inconsistency between the first data and the second data or an inaccuracy in a billing code would have a level of impact exceeding a predetermined threshold. For instance, the billing code generator 102 may identify a second data and a third data each of which have a low admissibility value and a low weight but an inconsistency between the first data and the combined second data and third data may have a level of impact that exceeds a particular threshold. In determining whether to generate the request to review, the billing code generator 102 may take into account multiple factors including any combination of one or more of weight, admissibility, cost, and value.

In one embodiment, the billing code generator 102 transmits the request for review to a user of the billing code generator 102. In another embodiment, the billing code generator 102 transmits the request for review to a user of a second computing device 101b, the user having generated a report including the first data. Note that any of the requests disclosed herein may be generated and provided to the physician or other user at any time. For example, the techniques disclosed herein may be applied while a physician or other user is dictating or otherwise generating a report. As a result, a request may be generated and provided to the physician or other user in real-time, i.e., while the user is generating the report (e.g., while the user is dictating the report, immediately or soon after the user has dictated the portion of the report that triggered the request, but before the user has dictated the entire report). In other words, it is not required that the entire report be generated before a request is made to the user who dictated or otherwise generated the report.

In some embodiments, to apply the techniques described herein while a user is generating data, the billing code generator 102 receives a first portion of the data during generation of a second portion of the data; the billing code generator 102 analyzes the first portion of the first data and identifies the first portion as first data relating to the fact and admissible in the billing process, based on the analysis. For example, in an embodiment where a physician is dictating a physician's report, the physician may provide completed portions of the report to the billing code generator 102 for analysis while finishing other, uncompleted portions of the report; in this way, the system can alert the physician about additional information required before the physician completes an initial version of the report. In one of these embodiments, the billing code generator 102 transmits the request for review to a user of the billing code generator 102 during generation of the first data.

Although described herein as a system in which a user directly accesses the billing code generator 102, in some embodiments, a second computing device 101b interacts with the billing code generator 102 instead. In one of these embodiments, a user accesses the second computing device 101b to generate data and the second computing device 101b interacts with the billing code generator 102 for analysis of the data and a determination as to whether to issue a request to the user for review of the data. By way of example, the second computing device 101b may execute an automatic speech recognition engine (ASR) with which a user of the second computing device 101b generates data (e.g., because the ASR creates source data based on the user's speech). Continuing with this example, the ASR may create a first portion of the first data based on the user's speech while the user is speaking and provide the first portion to the billing code generator 102 for analysis while the user continues to speak and the ASR continues to generate and transmit to the billing code generator 102 subsequent portions of the first data for additional analyses.

Alternatively, for example, the techniques disclosed herein may be applied after the physician or other user has dictated or otherwise generated a report. For example, a user may dictate a report, and the dictated report may be stored and/or transmitted to another location, and the dictation may be transcribed in another location and/or at another time, possibly by a computer or other system controlled by a user other than the speaker who dictated the report; for instance, a user of a second computing device 101b may dictate the report and store the dictation on the second computing device 101b, while the transcription of the dictation may occur on a third computing device 101c. At this later time, the techniques disclosed herein may be applied to the transcript; for example, the third computing device 101c may transmit the transcript to the billing code generator 102 executing on the computing device 101. As a result, in this scenario it may be necessary to contact the physician or other dictating user after the user has finished dictating or otherwise creating the report.

Although in the examples above the “request” is described as a request to a physician, this is merely an example and does not constitute a limitation of the present invention. More generally, the request may be a request to any source of data, such as a source of data that has a high weight and/or a high admissibility value. The request may be a request to a human or to a computer-based system, such as an EMR system. The response to the request may, therefore, be provided manually (as in the case of a request made to a physician) or automatically (as in the case of a request made to an EMR system). Furthermore, the request may include requests to individuals or systems other than a physician. For example, in some situations, the billing code generator 102 may generate a request to an electronic medical records system. As another example, the billing code generator 102 may store the request as a data record and not transmit the data record. Once stored, the request may subsequently be transmitted to another computing device or retrieved for display by the billing code generator 102; for example, the billing code generator 102 may transmit the request to a second computing device 101b, and another system may request access to the request or a user may request a display of the request. As an alternative example, the billing code generator 102 may generate an indication that the first data is missing information or that there is information that conflicts with the first data; the billing code generator 102 may associate such an indication with the first data such that a reviewer of the first data will also see the indication (e.g., by embedding text into the first data, rendering the indication when the first data is rendered, or otherwise bringing the indication to a reviewer's attention). As discussed above in connection with FIG. 2E, the billing code generator 102 may determine that the first data is missing information by comparing the first data to second data (which may be admissible or inadmissible data) and determining that the second data contains information the first data does not contain.

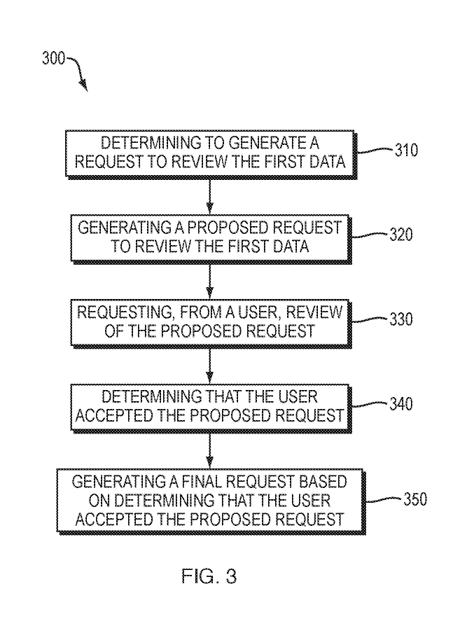

The request itself may be generated automatically, or may be made only after review and approval by a human billing coder. Referring now to FIG. 3, a flow diagram depicts one embodiment of a method 300 in which the billing code generator 102 generates a proposed request for approval by a user. As shown in FIG. 3, the method 300 includes determining to generate a request to review the first data (310). The determination may be made as described in connection with FIGS. 2C-2G. The method 300 includes generating a proposed request (320). The method 300 includes requesting, from a user, review of the proposed request (330). In one embodiment, the user is a human billing coder who reviews the output of the billing code generator 102. The method 300 includes determining that the user accepted the proposed request (340). The method 300 includes generating a final request based on determining that the user accepted the proposed request (350). In some embodiments, the billing code generator 102 does not generate the final request unless a human billing coder has approved the proposed request.

Embodiments of the present invention have a variety of advantages. For example, embodiments of the present invention enable billing coding information to be generated more accurately and with a higher degree of completeness than is possible when using existing Computer Assisted Billing Coding (CAC) systems, because embodiments of the present invention are capable of using evidence that is not directly admissible for billing to determine whether to request missing information or to request clarification of inconsistent information. As a result, embodiments of the present invention may enable healthcare providers to achieve a higher rate of reimbursement at a lower cost than is now presently achievable.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Inadmissible sources of data that may be used by embodiments of the present invention may include narrative freeform text (such as the text typically found in word processing documents), discrete data elements (such as the data elements typically found in an EMR or other database record), or any combination of the two.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method performed by at least one computer processor executing computer program instructions stored on at least one non-transitory computer-readable medium, the method comprising:
(A) receiving first data that is admissible as evidence in a billing process;
(B) identifying a source of the first data;
(C) assigning an admissibility value to the first data, based on the source of the first data;
(D) assigning a weight to the first data, based on the source of the first data;
(E) receiving second data that is inadmissible as evidence in the billing process;
(F) identifying a source of the second data, wherein the source of the first data differs from the source of the second data;
(G) assigning an admissibility value to the second data, based on the source of the second data, wherein the admissibility value assigned to the first data differs from the admissibility value assigned to the second data;
(H) assigning a weight to the second data, based on the source of the second data, wherein the weight assigned to the first data differs from the weight assigned to the second data;
(I) determining, based on the first data, the admissibility value assigned to the first data, the weight assigned to the first data, the second data, the admissibility value assigned to the second data, and the weight assigned to the second data, whether to generate a request to review the first data; and
(J) generating the request automatically based on the determination in (I).

2. The method of claim 1, wherein (A) comprises using an electronic master patient index to search a billing source database for data having a common identifier to produce the first data.

3. The method of claim 1, wherein (A) comprises:
(A)(1) using an automatic speech recognizer (ASR) to recognize first speech of a user to generate the first data;
(A)(2) receiving the first data at a billing code generator while the ASR is recognizing second speech of the user to generate third data that is admissible as evidence in the billing process.

4. The method of claim 1, wherein (B) comprises identifying the source of the first data based on information contained within the first data.

5. The method of claim 1, wherein (C) comprises evaluating a rule in connection with the first data to assign the admissibility value to the first data.

6. The method of claim 1, wherein (I) comprises determining not to generate the request in response to determining that the weight assigned to the second data is less than a predetermined threshold.

7. The method of claim 1, wherein (I) comprises determining whether the second data contains information that is inconsistent with information contained in the first data.

8. The method of claim 1, wherein (I) comprises determining whether the second data contains information that is not contained in the first data.

9. The method of claim 1, wherein (I) comprises determining whether the first data contains information that is not contained in the second data.

10. The method of claim 1, wherein the second data comprises data in a HR7-CCD record.

11. The method of claim 1, further comprising:
(K) receiving a response to the request; and
(L) in response to receiving the response, generating a billing code based on the first data and the second data.

12. The method of claim 1, wherein (J) comprises transmitting the request to a computing device.

13. A system comprising at least one non-transitory computer-readable medium containing computer program instructions executable by at least one computer processor to perform a method, the method comprising:
(A) receiving first data that is admissible as evidence in a billing process;
(B) identifying a source of the first data;
(C) assigning an admissibility value to the first data, based on the source of the first data;
(D) assigning a weight to the first data, based on the source of the first data;
(E) receiving second data that is inadmissible as evidence in the billing process;
(F) identifying a source of the second data, wherein the source of the first data differs from the source of the second data;
(G) assigning an admissibility value to the second data, based on the source of the second data, wherein the admissibility value assigned to the first data differs from the admissibility value assigned to the second data;
(H) assigning a weight to the second data, based on the source of the second data, wherein the weight assigned to the first data differs from the weight assigned to the second data;
(I) determining, based on the first data, the admissibility value assigned to the first data, the weight assigned to the first data, the second data, the admissibility value assigned to the second data, and the weight assigned to the second data, whether to generate a request to review the first data; and
(J) generating the request automatically based on the determination in (I).

14. The system of claim 13, wherein (A) comprises using an electronic master patient index to search a billing source database for data having a common identifier to produce the first data.

15. The system of claim 13, wherein (A) comprises:
(A)(1) using an automatic speech recognizer (ASR) to recognize first speech of a user to generate the first data;
(A)(2) receiving the first data at a billing code generator while the ASR is recognizing second speech of the user to generate third data that is admissible as evidence in the billing process.

16. The system of claim 13, wherein (B) comprises identifying the source of the first data based on information contained within the first data.

17. The system of claim 13, wherein (C) comprises evaluating a rule in connection with the first data to assign the admissibility value to the first data.

18. The system of claim 13, wherein (I) comprises determining not to generate the request in response to determining that the weight assigned to the second data is less than a predetermined threshold.

19. The system of claim 13, wherein (I) comprises determining whether the second data contains information that is inconsistent with information contained in the first data.

20. The system of claim 13, wherein (I) comprises determining whether the second data contains information that is not contained in the first data.

21. The system of claim 13, wherein (I) comprises determining whether the first data contains information that is not contained in the second data.

22. The system of claim 13, wherein the second data comprises data in a HR7-CCD record.

23. The system of claim 13, wherein the method further comprises:
(K) receiving a response to the request; and
(L) in response to receiving the response, generating a billing code based on the first data and the second data.

24. The system of claim 13, wherein (J) comprises transmitting the request to a computing device.
